(19) United States
(12) Patent Application Publication
(10) Pub. No.: US 2024/0426495 A1
(43) Pub. Date: Dec. 26, 2024

(54) CLEANING BELT FOR ELECTRONIC AIR CLEANER

(71) Applicant: Carrier Corporation, Palm Beach Gardens, FL (US)

(72) Inventor: Peter McKinney, Boulder, CO (US)

(21) Appl. No.: 18/748,671

(22) Filed: Jun. 20, 2024

Related U.S. Application Data
(60) Provisional application No. 63/509,886, filed on Jun. 23, 2023.

(51) Int. Cl. F24F 8/90; B03C 3/41; B03C 3/74; B08B 1/16; B08B 1/30; F24F 8/192

(52) U.S. Cl. CPC F24F 8/90; B03C 3/41; B03C 3/743; B08B 1/16; B08B 1/30; B03C 2201/10; F24F 8/192

(57) ABSTRACT

A cleaning system for cleaning at least one electrode of an electronic air cleaner includes a drive mechanism, at least one support operably coupled to the drive mechanism, and a continuous belt engaged with the at least one support. The continuous belt includes one or more cleaning teeth extending from a surface of the continuous belt and the one or more cleaning teeth are coplanar with the at least one electrode.

### CROSS-REFERENCE TO RELATED APPLICATIONS

This application claims the benefit of U.S. Application No. 63/509,886, filed Jun. 23, 2023, the contents of which are incorporated by reference herein in their entirety.

### BACKGROUND

Embodiments of the present disclosure relate to the art of air treatment, and more particularly, a cleaning mechanism for cleaning an electronic ionization device.

Air and other fluids are commonly cleaned or purified in a variety of applications. For example, in air conditioning systems, the air to be delivered to an area being conditioned is not only conditioned, but also is filtered or otherwise treated prior to delivery. One device commonly used to perform such treatment is an electronic air cleaner. However, the performance of an electronic air cleaner may degrade over time as compounds and particulates in the air being treated adhere to the surface of the electrode(s).

### BRIEF DESCRIPTION

According to an embodiment, a cleaning system for cleaning at least one electrode of an electronic air cleaner includes a drive mechanism, at least one support operably coupled to the drive mechanism, and a continuous belt engaged with the at least one support. The continuous belt includes one or more cleaning teeth extending from a surface of the continuous belt.

In addition to one or more of the features described herein, or as an alternative, further embodiments may include that the one or more cleaning teeth are formed from a resilient material such that the one or more cleaning teeth are configured to flex relative to the continuous belt.

In addition to one or more of the features described herein, or as an alternative, further embodiments may include that the at least one support includes a first support and a second support and the first support is operably coupled to the drive mechanism.

In addition to one or more of the features described herein, or as an alternative, further embodiments may include that the second support is a passive support.

In addition to one or more of the features described herein, or as an alternative, further embodiments may include that the drive mechanism is embedded within the at least one support.

In addition to one or more of the features described herein, or as an alternative, further embodiments may include that the at least one support includes a drive feature configured to cooperate with the continuous belt to move the continuous belt.

In addition to one or more of the features described herein, or as an alternative, further embodiments may include that the drive feature includes a plurality of teeth and the continuous belt includes a plurality of corresponding drive teeth, the plurality of teeth being configured to intermesh with the plurality of drive teeth to move the continuous belt.

In addition to one or more of the features described herein, or as an alternative, further embodiments may include that the drive feature includes a frictional surface.

In addition to one or more of the features described herein, or as an alternative, further embodiments may include that the drive feature is configured to cooperate with another surface of the continuous belt opposite the surface from which the one or more cleaning teeth extend.

In addition to one or more of the features described herein, or as an alternative, further embodiments may include that the drive feature is configured to engage an interior surface of the continuous belt.

In addition to one or more of the features described herein, or as an alternative, further embodiments may include that the drive feature is configured to engage an exterior surface of the continuous belt.

In addition to one or more of the features described herein, or as an alternative, further embodiments may include at least one post associated with the at least one electrode, the at least one post being positioned upstream from the at least one electrode relative to a path of movement of the continuous belt, the at least one post being arranged within a path of movement of the one or more cleaning teeth to hold the one or more cleaning teeth away from the at least one electrode for a portion of the path of movement.

In addition to one or more of the features described herein, or as an alternative, further embodiments may include that the drive mechanism is operable to drive the belt in a first direction of travel and a second opposite direction of travel.

In addition to one or more of the features described herein, or as an alternative, further embodiments may include that the one or more cleaning teeth form the drive mechanism.

According to an embodiment, an electronic air cleaner includes a brush array, an ionizing system including a brush assembly having at least one electrode mounted to the brush array and a cleaning system connected to the brush array. The cleaning system includes a continuous belt movable to contact the at least one electrode.

In addition to one or more of the features described herein, or as an alternative, further embodiments may include that the at least one electrode further comprises a plurality of electrodes and the continuous belt is operable to contact the plurality of electrodes.

In addition to one or more of the features described herein, or as an alternative, further embodiments may include that the continuous belt further comprises at least one cleaning tooth extending from a surface of the continuous belt, the at least one cleaning tooth being coplanar with and configured to contact the at least one electrode.

In addition to one or more of the features described herein, or as an alternative, further embodiments may include that the at least one electrode includes a plurality of electrodes, and the at least one cleaning tooth includes a plurality of cleaning teeth, wherein a total number of the plurality of cleaning teeth is less than or equal to a total number of the plurality of electrodes.

In addition to one or more of the features described herein, or as an alternative, further embodiments may include at least one post positioned upstream from the at least one electrode relative to a path of movement of the continuous belt, the at least one post being arranged within a path of movement of the at least one cleaning tooth.

In addition to one or more of the features described herein, or as an alternative, further embodiments may include that the cleaning system further comprises a drive mechanism and at least one support engaged with a surface of the continuous belt, the at least one support being operably coupled to the drive mechanism.

In addition to one or more of the features described herein, or as an alternative, further embodiments may include that the drive mechanism is embedded within the at least one support.

### BRIEF DESCRIPTION OF THE DRAWINGS

The following descriptions should not be considered limiting in any way. With reference to the accompanying drawings, like elements are numbered alike:

FIG. 1 is a plan view of an exemplary electronic air cleaner having a cleaning assembly system mounted thereto according to an embodiment;

FIG. 2 is a schematic diagram of an exemplary ionizing system of an electronic air cleaner according to an embodiment; and

FIG. 3A is a perspective view of an exemplary belt for use in a cleaning system according to an embodiment;

FIG. 3B is a perspective view of an exemplary belt and supports for use in a cleaning system according to an embodiment; and

FIG. 4 is a perspective view of a portion of an exemplary electronic air cleaner having a cleaning system mounted thereto according to an embodiment.

### DETAILED DESCRIPTION

A detailed description of one or more embodiments of the disclosed apparatus and method are presented herein by way of exemplification and not limitation with reference to the Figures.

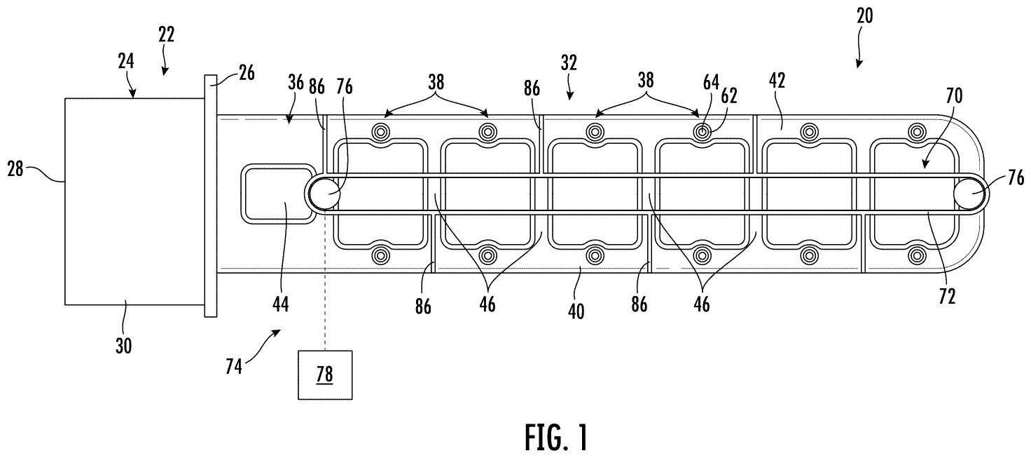

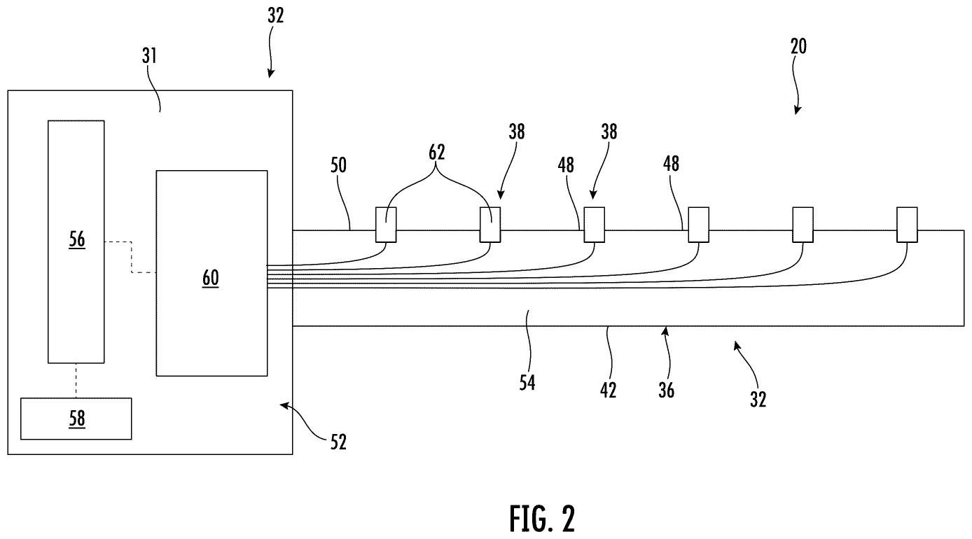

With reference to FIG. 1, an exemplary electronic air cleaner 20 is illustrated. As shown, the air cleaner 20 includes a housing 22 having a first portion or base 24 and a second portion or cover 26. The cover 26 may be removably coupled to the base 24, such as via a plurality of fasteners, a snap fit connection, or in any other suitable manner. Alternatively, the cover 26 may be permanently affixed to the base 24. In an embodiment, the base 24 includes a bottom 28 arranged at a first end and a plurality of sidewalls 30 extending from the bottom 28 in the same direction such that a hollow interior or cavity 31 (see FIG. 2) is defined therebetween. The cover 26 may be configured to mount to the distal end of the plurality of sidewalls 30 to substantially seal the open end of the cavity 31. However, it should be understood that embodiments where the cavity 31 is formed in the cover 26 and embodiments where the cavity 31 is defined by both the cover 26 and the base 24 in combination are also contemplated herein.

Extending from the cover 26 in a direction away from the base 24 is a brush array 32. As shown, the brush array 32 may be arranged substantially orthogonal to the adjacent surface 34 of the cover 26. However, embodiments where the brush array 32 has another orientation relative to the cover 26 are within the scope of the disclosure. In an embodiment, the brush array 32 is a separate component fixedly or removably mounted to the cover 26. In another embodiment, the brush array 32 is integrally formed with the cover 26.

In the illustrated, non-limiting embodiment, the brush array 32 includes a body or structural member 36 capable of supporting one or more brush assemblies 38. The brush array 32 may be formed as a single unitary body, or alternatively, may be formed by connecting multiple components, such as an upper portion and a lower portion for example. As shown, the body 36 may have a first arm 40 and second arm 42 arranged parallel to one another and separated by a clearance 44. The first and second arms 40, 42 may be connected at a distal end thereof, as shown, such that the body 36 is generally U-shaped. Further, the first and second arm 40, 42 may be substantially identical and/or the thickness of the body 36, measured perpendicular to the longitudinal axis of the body 36, may be constant or may vary. It should be understood that embodiments where the brush array 32 has another configuration, such as a circular configuration for example, are also contemplated herein.

In some embodiments, such as where the body 36 is configured to support a plurality of brush assemblies 38 and therefore is generally elongated in the longitudinal direction, the brush array 32 may additionally one or more cross-members 46 that span the clearance 44 to connect the first arm 40 and the second arm 42. Inclusion of a cross-member 46 may increase the structural rigidity of the body 36. The cross-members 46 may be separate components or may be integrally formed with one or both of the first and second arms 40, 42. It should be understood that the electronic air cleaner 20 illustrated and described herein is intended as an example only, and that an electronic air cleaner having any suitable configuration is within the scope of the disclosure.

In the illustrated, non-limiting embodiment, a plurality of openings or bores 48 (shown in FIG. 2) are formed in an upper surface 50 of body 36. The total number of openings 48 will vary based on the total number of brush assemblies. Although the openings 48 are formed in each of the arms 40, 42 and each opening 48 is axially aligned with at least one opening on the same arm and at least one opening on the opposite arm, embodiments where the openings 48 are not aligned with one another are also contemplated herein. In other embodiments, the body or structural member 36 of the brush array 32 may be configured as an electrical conductor and each of the brush assemblies 38 is simply attached to the conductive body 36. In such embodiments, the brush assemblies 38 need not be arranged within a corresponding opening 48 formed in the body 36.

In an embodiment, the electronic air cleaner 20 additionally includes an ionizing system 52 (see FIG. 2). All or a portion of the ionizing system 52 may be arranged within the cavity 31 of the housing 22. At least part of the body 36 of the brush array 32, such as the first arm 40 and the second arm 42 for example, has a hollow interior 54. Accordingly, in an embodiment, a portion of the ionizing system 52 is arranged within the body 36 of the brush array 32, such as within hollow interior 54. The ionizing system 52 may include a circuit board 56 and a power supply 58 operably coupled to the circuit board 56 to provide power to one or more components of the air cleaner 20. The ionizing system 52 may additionally include an ion generation device 60 that is operably coupled to the circuit board 56 and is configured to receive power therefrom to produce ions. In an embodiment, the ion generation device 60 is configured to generate a single type of polarity of high voltage. In other embodiment, the ion generation device 60 is operable to produce two polarities of high voltage. In such instances, the polarities may be configured to alternate on all brush assemblies, or alternatively, some brush assemblies may be configured to receive a first continuous polarity and other brush assemblies may be configured to receive a second continuous polarity.

The one or more brush assemblies 38 are connected to the ion generation device 60. In the illustrated, non-limiting embodiment, each brush assembly 38 includes at least one electrode or high voltage wire 62 that extends through the hollow interior 54 of the body 36 and an opening 48 formed in the body 36 of the brush array 32. However, as previously noted, in embodiments where the body is conductive, the brush assemblies 38 may be mounted and electrically connected thereto in any suitable manner.

In embodiments where a brush assembly includes a plurality of electrodes, such as two electrodes 62 for example, the electrodes are mounted via two separate respective openings 48, such as an opening in the first arm 40 and an axially aligned opening 48 in the second arm 42. However, embodiments where the two electrodes are mounted to the same portion of the body 36, such as the same arm for example, are also contemplated herein.

In an embodiment, the electrode 62 contains a brush 64 including a plurality of bristles that extend outwardly from the brush 64. However, in other embodiments, the electrode 62 may be a flexible electrode including a brush having a single bristle, or alternatively, a rigid sharp electrode, having a needle point, pin tip, or other shape protrusion. The brush 64 may be made of any suitable material that conducts electricity. In the illustrated, non-limiting embodiment, the ionizing system 52 includes six brush assemblies 38, each having two electrodes 62. However, embodiments where the ionizing system 52 includes any number of brush assemblies 38, including a single brush assembly or two brush assemblies, are also within the scope of the disclosure.

With continued reference to the FIG. 1, the electronic air cleaner 20 includes at least one cleaning system 70 operable to clean one or more of the brush assemblies 38. In the illustrated non-limiting embodiment, the cleaning system 70 includes a continuous belt 72 positioned adjacent the upper surface of the structural member 36. A drive system 74 coupled to the continuous belt 72 is operable to drive the continuous belt 72 relative to the structural member 36 and brush assemblies 38. As shown, the drive system 74 includes one or more supports 76, such as pulleys or sprockets for example, about which the belt 72 is mounted. Rotation of one or more of the supports 76 is configured to drive rotation of the belt 72.

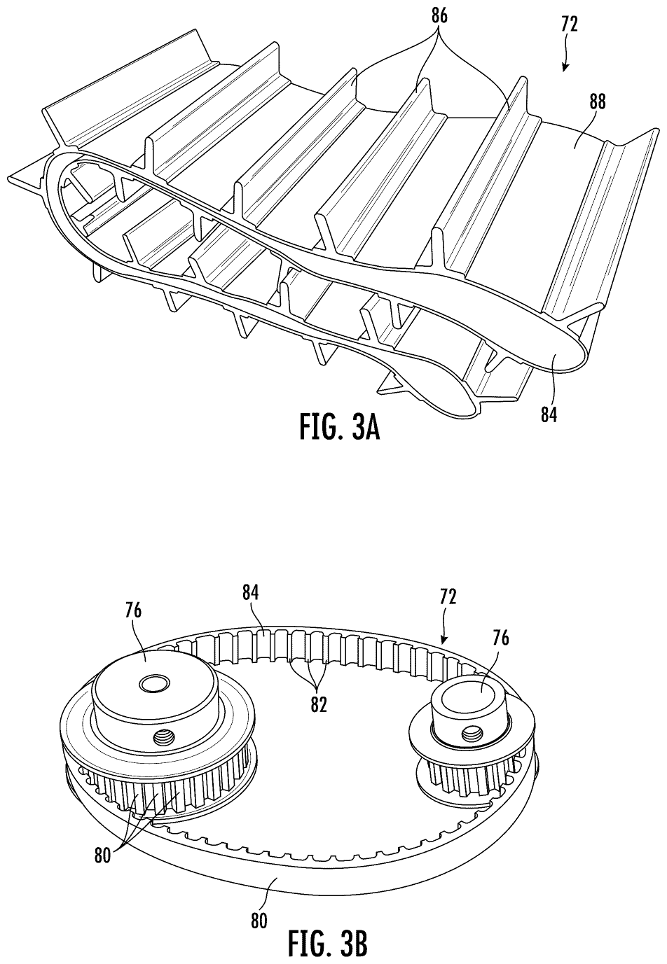

In the illustrated, non-limiting embodiment of FIG. 3B, the at least one support 76 has a drive feature 80, such as a plurality of teeth for example, configured to intermesh with or engage a plurality of corresponding drive teeth 82 formed at a surface of the belt 72, such as an interior surface 84 of the belt 72 for example. However, embodiments where a support 76 engages with the belt 72 in another suitable manner to drive the belt 72, such as where the drive feature includes a frictional surface resulting in frictional engagement for example, are also contemplated herein.

The at least one support 76 includes a driven support, which is also referred to herein as a “drive support.” A motor or another suitable drive mechanism 78, may be separate from and operably coupled to the drive support 76, such as via a rotatable shaft for example. However, in other embodiments, the drive mechanism 78 may be integrally formed or embedded within the support. It should be understood that the drive mechanism 78 need not be electrically powered. For example, in an embodiment, the drive mechanism may be configured to capture the power of an airflow flow of air passing over the drive mechanism 78 similar to a wind turbine.

In embodiments including a plurality of supports 76, a first support 76 may be a drive support and a second support 76 may be a passive support configured to rotate freely in response to engagement with the belt 72. Examples of a passive support include but are not limited to a post upon which the belt 72 slides, a rotating bushing, or a rotating cylinder on bearings for example. In another embodiment, the drive system 74 may include multiple drive supports. For example, a first drive support may be configured to drive the belt 72 in a first direction and the second drive support may be operable to drive the belt 72 in a second, opposite direction. However, embodiments where a single drive support 76 is operable to drive the belt 72 in both a first direction and a second direction are also contemplated herein.

As best shown in FIGS. 1 and 3A, the continuous belt 72 includes at least one cleaning tooth 86 protruding from a surface of the belt 72 such that a portion of the cleaning tooth 86 is coplanar with a portion of a brush assembly 38, such as with an electrode 62 for example. The at least one cleaning tooth 86 may be integrally formed with the belt 72, or alternatively, may be coupled thereto. Accordingly, the at least one cleaning tooth 86 may be formed from the same material as the belt 72 or from a different material than the belt 72. In an embodiment, the at least one cleaning tooth 86 is arranged at an opposite surface of the belt 72 as the surface configured to engage the support(s) 76. Although the one or more cleaning teeth 86 are illustrated as protruding from an exterior surface 88 and the supports 76 are configured to engage an interior surface 84 of the belt 72 in the FIGS., embodiments where the cleaning teeth 86 are arranged at an interior surface 84 and the supports 76 engage and drive an exterior surface 88 of the belt are also within the scope of the disclosure. Further, embodiments where the cleaning teeth 86 and the drive feature 80 are arranged at the same side of the belt 72 are also contemplated herein.

In the illustrated, non-limiting embodiment, the belt 72 includes a plurality of cleaning teeth 86, such as six cleaning teeth for example. However, it should be understood that embodiments having any number of cleaning teeth 86 including a single cleaning tooth, two cleaning teeth, three cleaning teeth, four cleaning teeth, five cleaning teeth, and more than six cleaning teeth are contemplated herein. Although the cleaning teeth 86 are shown spaced at equidistant intervals about the belt 72, embodiments where the spacing between adjacent cleaning teeth 86 varies are also contemplated herein. In an embodiment, the spacing between adjacent cleaning teeth may be selected as a multiple of the spacing between adjacent brush assemblies 38 in order to allow the belt 72 to be stopped in a position where none of the cleaning teeth 86 are arranged in contact with or are located directly adjacent to a brush electrode 62.

Further, in embodiments including a plurality of cleaning teeth 86, the plurality of cleaning teeth may be substantially identical, or alternatively, may have varying configurations. In embodiments where one or more parameters of the cleaning teeth 86 vary, such as a length of the cleaning teeth (measured perpendicular to the surface of the belt 72) for example, different teeth 86 may be configured to clean different brush assemblies 38.

The total number of cleaning teeth 86 may be equal to or less than the total number of brush assemblies 38 to be cleaned by the cleaning system 70 as shown. For example, a ratio of cleaning teeth 86 to brush assemblies 38 associated with the cleaning teeth 86 may be between 1:6 and 3:4. In an embodiment, the ratio of cleaning teeth 86 to brush assemblies 38 is 1:2. Although a single cleaning system 70 is operable to clean each of the brush assemblies 38 of the electronic air cleaner 20 in FIG. 1, in other embodiments, the electronic air cleaner 20 may include a plurality of cleaning systems 70, each being associated with a respective portion of the brush assemblies 38. In such embodiments, the plurality of cleaning systems 70 may be operably coupled to one another, such as via a shared motor 78 for example, or alternatively, may operate independently.

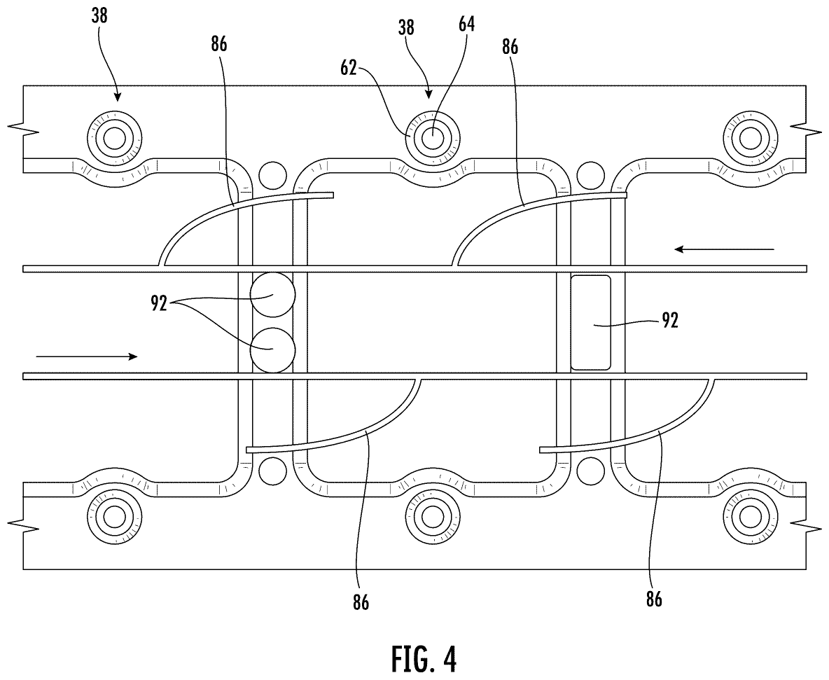

In an embodiment, the cleaning teeth 86 are formed from an elastic or resilient material configured to flex, such as in response to engagement with one of the brush assemblies 38. With reference now to FIG. 4, at least one post 90 may extend from a surface of the structural member 36 at a location upstream from one of the brush assemblies 38 relative to a direction of travel or path of movement of the belt 72. In an embodiment, the cleaning system 70 includes a plurality of posts 90, each being associated with a respective brush assembly 38. Each post 90 is positioned within a path of movement of a cleaning tooth 86. Accordingly, as a cleaning tooth 86 approaches the brush assembly 38, the cleaning tooth 86 engages the post 90, causing the cleaning tooth 86 to bend backwards relative to the belt 72. The cleaning tooth 86 may remain in this bent configuration until a forward or fixed end of the cleaning tooth 86 is generally at the brush assembly. At this position, the distal end of the cleaning tooth 86 separates from the post 90. The resiliency of the material of the cleaning tooth 86 may causes the tooth to flex back to a neutral position just in time to engage the adjacent brush assembly 38. However, it should be understood that operation of the belt 72 in random or alternating directions could help prevent the cleaning teeth 86 from plastically deforming due to repeated flexing in the same direction.

Alternatively, or in addition, the at least one cleaning system 70 may include one or more backing supports 92, such as positioned between opposite interior facing sides of the belt 72. Inclusion of these backing supports 92 may prevent the belt 72 from flexing inwardly, away from the brush assemblies 38. In an embodiment, the at least one backing support 92 is configured as a generally rectangular block. In another embodiment, the at least one backing support is configured as a plurality of cylindrical posts, with a different post arranged adjacent to each of the interior surfaces of the belt. In such embodiments, the cylindrical posts could be rotatable bushings to facilitate the sliding movement of the belt 72.

A cleaning system 70 for an electronic air cleaner 20 as described herein allows a plurality of brush assemblies 38 arranged in a linear array to be cleaned automatically. Furthermore, the cleaning teeth of the belt 72 would provide sufficient cleaning even if moving at slow drive speeds. In addition, when a cleaning system 70 is non-operational, it is desirable for the cleaning teeth 86 to be isolated from or positioned out of contact with the brush assemblies 38. By including posts 90 as described with respect to FIG. 4, the likelihood of a cleaning tooth 86 being arranged in contact with a brush assembly 38 when movement of the belt 72 is stopped is significantly reduced, thereby allowing the cleaning system 70 to be suitably stopped at any time.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cleaning system for cleaning at least one electrode of an electronic air cleaner, the cleaning system comprising:
a drive mechanism;
at least one support operably coupled to the drive mechanism; and
a continuous belt engaged with the at least one support, the continuous belt including one or more cleaning teeth extending from a surface of the continuous belt.

2. The cleaning system of claim 1, wherein the one or more cleaning teeth are formed from a resilient material such that the one or more cleaning teeth are configured to flex relative to the continuous belt.

3. The cleaning system of claim 1, wherein the at least one support includes a first support and a second support and the first support is operably coupled to the drive mechanism.

4. The cleaning system of claim 3, wherein the second support is a passive support.

5. The cleaning system of claim 1, wherein the drive mechanism is embedded within the at least one support.

6. The cleaning system of claim 1, wherein the at least one support includes a drive feature configured to cooperate with the continuous belt to move the continuous belt.

7. The cleaning system of claim 6, wherein the drive feature includes a plurality of teeth and the continuous belt includes a plurality of corresponding drive teeth, the plurality of teeth being configured to intermesh with the plurality of drive teeth to move the continuous belt.

8. The cleaning system of claim 6, wherein the drive feature includes a frictional surface.

9. The cleaning system of claim 6, wherein the drive feature is configured to cooperate with another surface of the continuous belt opposite the surface from which the one or more cleaning teeth extend.

10. The cleaning system of claim 6, wherein the drive feature is configured to engage an interior surface of the continuous belt.

11. The cleaning system of claim 6, wherein the drive feature is configured to engage an exterior surface of the continuous belt.

12. The cleaning system of claim 1, further comprising at least one post associated with the at least one electrode, the at least one post being positioned upstream from the at least one electrode relative to a path of movement of the continuous belt, the at least one post being arranged within a path of movement of the one or more cleaning teeth to hold the one or more cleaning teeth away from the at least one electrode for a portion of the path of movement.

13. The cleaning system of claim 1, wherein the drive mechanism is operable to drive the belt in a first direction of travel and a second opposite direction of travel.

14. The cleaning system of claim 1, wherein the one or more cleaning teeth form the drive mechanism.

15. An electronic air cleaner comprising:
a brush array;
an ionizing system including a brush assembly having at least one electrode, the at least one electrode being mounted to the brush array; and
a cleaning system connected to the brush array, the cleaning system including a continuous belt movable to contact the at least one electrode.

16. The electronic air cleaner of claim 15, wherein the at least one electrode further comprises a plurality of electrodes and the continuous belt is operable to contact the plurality of electrodes.

17. The electronic air cleaner of claim 15, wherein the continuous belt further comprises at least one cleaning tooth extending from a surface of the continuous belt, the at least one cleaning tooth being coplanar with and configured to contact the at least one electrode.

18. The electronic air cleaner of claim 17, wherein the continuous belt is driven in response to an airflow.

19. The electronic air cleaner of claim 15, wherein the cleaning system further comprises:
a drive mechanism; and
at least one support engaged with a surface of the continuous belt, the at least one support being operably coupled to the drive mechanism.

20. The electronic air cleaner of claim 19, wherein the drive mechanism is embedded within the at least one support.
